(19) United States
(12) Patent Application Publication
(10) Pub. No.: US 2021/0342752 A1
(43) Pub. Date: Nov. 4, 2021

(54) INFORMATION PROCESSING DEVICE, INFORMATION PROCESSING SYSTEM, PROGRAM, AND VEHICLE

(71) Applicant: TOYOTA JIDOSHA KABUSHIKI KAISHA, Toyota-shi (JP)

(72) Inventors: Tooru NAKANISHI, Nagakute-shi (JP); Tadashi YAMADA, Toyota-shi (JP); Josuke YAMANE, Nissin-shi (JP); Mitsuhiro MIURA, Toyota-shi (JP); Tomo SASAKI, Toyota-shi (JP); Tomoyuki KOZUKA, Toyota-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 17/218,278

(22) Filed: Mar. 31, 2021

(30) Foreign Application Priority Data
May 1, 2020 (JP) 2020-081447

(51) Int. Cl. G06Q 10/02; G06Q 30/02

(52) U.S. Cl. CPC G06Q 10/02; H04W 4/44; G06Q 30/0267; G06Q 30/0269

(57) ABSTRACT

An information processing device includes a control unit. The control unit a control unit that acquires traveling information and location information of a vehicle acquired based on past traveling of at least one vehicle for one occupant of the vehicle, the vehicle included in the at least one vehicle, generates preference information of the one occupant based on the traveling information and the location information that are acquired, and determines destination information based on the preference information of the occupant when the control unit determines that an occupant who is on board the vehicle is the one occupant who has boarded the vehicle in the past and the preference information is generated for the occupant.

### CROSS-REFERENCE TO RELATED APPLICATION

This application claims priority to Japanese Patent Application No. 2020-081447 filed on May 1, 2020, incorporated herein by reference in its entirety.

### BACKGROUND

### 1. Technical Field

The present disclosure relates to an information processing device, an information processing system, a program, and a vehicle.

### 2. Description of Related Art

In the related art, a technique using a car navigation device mounted on a vehicle is known. For example, Japanese Unexamined Patent Application Publication No. 2010-015270 (JP 2010-015270 A) discloses an in-vehicle information terminal including a car navigation device. With the in-vehicle information terminal, an occupant can easily use an electronic coupon of a facility even after occupants get off the vehicle.

### SUMMARY

In the related art, the occupants of the vehicle are uniformly provided with information output by the car navigation device. For example, it has been difficult for the car navigation device to provide each of the occupants with information tailored to preferences of the occupants.

An object of the present disclosure made in view of such circumstances is to make it possible to provide each of the occupants with information tailored to the preferences of the occupants.

An information processing device according to an embodiment of the present disclosure includes a control unit. The control unit acquires traveling information and location information of a vehicle acquired based on past traveling of at least one vehicle for one occupant of the vehicle, the vehicle included in the at least one vehicle, generates preference information of the one occupant based on the traveling information and the location information that are acquired, and determines destination information based on the preference information of the occupant when the control unit determines that an occupant who is on board the vehicle is the one occupant who has boarded the vehicle in the past and the preference information is generated for the occupant.

A program according to an embodiment of the present disclosure causes an information processing device to execute operations including acquiring traveling information and location information of a vehicle acquired based on past traveling of at least one vehicle for one occupant of the vehicle, the vehicle included in the at least one vehicle; traveling information and location information of the vehicle, generating preference information of the one occupant based on the traveling information and the location information that are acquired, determining whether an occupant who is on board the vehicle is the one occupant who has boarded the vehicle the past and the preference information is generated for the occupant, and determining destination information based on the preference information of the occupant when the information processing device determines that the occupant who is on board the vehicle is the one occupant who has boarded the vehicle in the past and the preference information is generated for the occupant.

A vehicle according to an embodiment of the present disclosure includes a control unit. The control unit acquires traveling information and location information of a vehicle acquired based on past traveling of at least one vehicle for one occupant of the vehicle, the vehicle included in the at least one vehicle, generates preference information of the one occupant based on the traveling information and the location information that are acquired, and determines destination information based on the preference information of the occupant when the control unit determines that an occupant who is on board the vehicle is the one occupant who has boarded the vehicle in the past and the preference information is generated for the occupant.

The information processing system, the information processing system, the program, and the vehicle according to the embodiment of the present disclosure, makes it possible to provide each occupant with the information that matches the preference of the occupants of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a configuration of an information processing system including an information processing device according to an embodiment of the present disclosure;

FIG. 2 is a functional block diagram showing a schematic configuration of each of the information processing device and a vehicle shown in FIG. 1;

FIG. 3 is a diagram for explaining a first example of processing executed by a control unit of the information processing device shown in FIG. 2;

FIG. 4 is a diagram for explaining a second example of the processing executed by the control unit of the information processing device shown in FIG. 2;

FIG. 5 is a diagram for explaining a third example of the processing executed by the control unit of the information processing device shown in FIG. 2;

FIG. 6 is a first diagram for explaining a fourth example of the processing executed by the control unit of the information processing device shown in FIG. 2;

FIG. 7 is a second diagram for explaining the fourth example of the processing executed by the control unit of the information processing device shown in FIG. 2;

FIG. 8 is a flowchart for explaining a first example of an information processing method executed by the information processing device shown in FIG. 1; and

FIG. 9 is a flowchart for explaining a second example of the information processing method executed by the information processing device shown in FIG. 1.

### DETAILED DESCRIPTION OF EMBODIMENTS

Hereinafter, embodiments of the present disclosure will be described below with reference to the drawings.

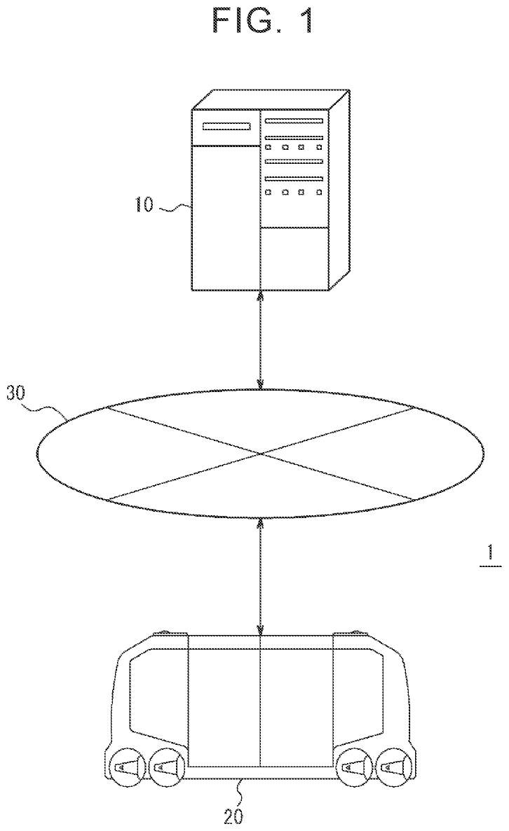

FIG. 1 is a configuration diagram showing a configuration of an information processing system 1 including an information processing device 10 according to an embodiment of the present disclosure. An outline of the information processing system 1 including the information processing device 10 according to the embodiment of the present disclosure will be mainly described with reference to FIG. 1. The information processing system 1 includes a vehicle 20 in addition to the information processing device 10. For convenience of explanation, FIG. 1 shows a single information processing device 10 and a single vehicle 20. However, the numbers of the information processing devices 10 and the vehicles 20 included in the information processing system 1 may be two or more. For example, an occupant may continuously use the same vehicle 20, or may use any one of a plurality of the vehicles 20 while changing the vehicle 20 every time the occupant is on board or for each predetermined period. Each of the information processing device 10 and the vehicle 20 are connected to a network 30 including a mobile communication network and the Internet, for example, so as to be communicable.

The information processing device 10 is one or a plurality of servers that can communicate with each other. The information processing device 10 is not limited to the above, and may be any general-purpose electronic device such as a personal computer (PC) or a smartphone, or may be another electronic device dedicated to the information processing system 1.

The vehicle 20 is, for example, an automobile. The vehicle 20 is not limited to this, and may be any vehicle that allows a human to board and drive to a destination. The vehicle 20 is, for example, a vehicle that performs automated driving. Automated driving includes, for example, Levels 1 to 5 defined by the Society of Automotive Engineers (SAE). However, automated driving is not limited to the above, and may be arbitrarily defined. The vehicle 20 is not limited to the vehicle that performs automated driving, and may be any vehicle driven by a driver.

As an outline of the embodiment, the information processing device 10 acquires traveling information and location information of the vehicle 20 acquired based on past traveling of one or more of the vehicles 20 for one occupant of the vehicle 20. In the present specification, the “travel information” includes, for example, arbitrary information acquired by the vehicle 20 in connection with traveling of the vehicle 20. For example, the traveling information includes a speed, acceleration, an angular velocity, a shift lever operation, a steering operation, a traveling lane, stop time, parking time, and an automated driving state of the vehicle 20.

The information processing device 10 generates preference information of the one occupant based on the traveling information and the location information that are acquired. In the present specification, the “preference information” includes, for example, preferences for food and drink, a method of eating and drinking, a hobby, of the occupant.

The information processing device 10 determines whether the occupant who is on board the vehicle 20 is the one occupant who has boarded the same or different vehicle 20 in the past and the preference information is generated for the occupant. When the information processing device 10 determines that the occupant who is on board the vehicle 20 is the one occupant who has boarded the same or different vehicle 20 in the past and the preference information is generated for the occupant, the information processing device 10 determines destination information based on the preference information of the occupant. In the present specification, the “destination information” includes information on the location information, types, equipment, etc. regarding facilities and destinations, etc. to which the vehicle 20 is required to travel. For example, the destination information includes the location information of a facility that reflects the preference of the occupant based on the preference information.

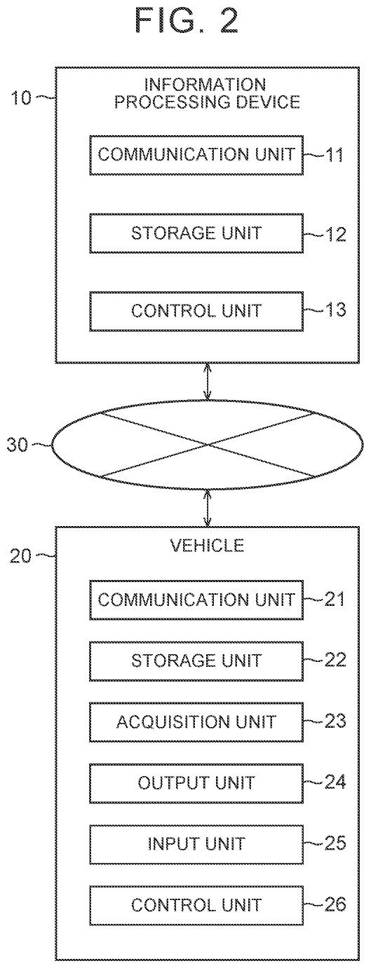

Next, with reference to FIG. 2, configurations of the information processing device 10 and the vehicle 20 included in the information processing system 1 will be mainly described. FIG. 2 is a functional block diagram showing a schematic configuration of each of the information processing device 10 and the vehicle 20 shown in FIG. 1.

As shown in FIG. 2, the vehicle 20 includes a communication unit 21, a storage unit 22, an acquisition unit 23, an output unit 24, an input unit 25, and a control unit 26. The communication unit 21, the storage unit 22, the acquisition unit 23, the output unit 24, the input unit 25, and the control unit 26 are connected to each other so as to be communicable with each other via an in-vehicle network such as a controller area network (CAN) or a dedicated line.

The communication unit 21 includes a communication module connected to the network 30. For example, the communication unit 21 may include a communication module corresponding to a mobile communication standard such as the fourth generation (4G) and the fifth generation (5G). According to the embodiment, the vehicle 20 is connected to the network 30 via the communication unit 21. The communication unit 21 transmits and receives various types of information via the network 30.

The storage unit 22 is, for example, a semiconductor memory, a magnetic memory, or an optical memory. However, the storage unit 22 is not limited to these memories. The storage unit 22 may function as, for example, a main storage device, an auxiliary storage device, or a cache memory. The storage unit 22 stores arbitrary information used for operating the vehicle 20. For example, the storage unit 22 stores the traveling information and the location information of the vehicle 20 acquired based on past traveling of the vehicle 20 for one occupant of the vehicle 20. In addition, for example, the storage unit 22 may store a system program, an application program, and various types of information received by the communication unit 21. The information stored in the storage unit 22 may be updatable with information received from the network 30 via the communication unit 21, for example.

The acquisition unit 23 includes an arbitrary module capable of acquiring various types of traveling information. For example, the acquisition unit 23 includes a sensor module capable of acquiring various types of traveling information above related to the vehicle 20 itself. The acquisition unit 23 includes an arbitrary module capable of acquiring various types of occupant information and the number of occupants. For example, the acquisition unit 23 includes a camera module, a microphone, and any other arbitrary sensor modules that are installed in a vehicle cabin of the vehicle 20, connected to the CAN, and capable of acquiring the occupant information and the number of the occupants. In the present specification, the “occupant information” includes age, gender, clothes, race, conversation contents, boarding time, behavior, etc. of the occupant of the vehicle 20. The acquisition unit 23 is not limited to the above, and may include any fingerprint sensor capable of acquiring a fingerprint of the occupant of the vehicle 20.

In addition, the acquisition unit 23 may include one or more receivers corresponding to any satellite positioning system. For example, the acquisition unit 23 may include a global positioning system (GPS) receiver. The acquisition unit 23 acquires a measured value of the location of the vehicle 20 as the location information. The location information includes, for example, an address, latitude, longitude, and altitude. The acquisition unit 23 may acquire the location information of the vehicle 20 constantly or may acquire the location information periodically or irregularly.

For example, the output unit 24 outputs, for example, the above destination information determined by the information processing device 10 to the occupants in the vehicle cabin of the vehicle 20. For example, the output unit 24 includes a car navigation device. For example, the output unit 24 includes an output device such as a liquid crystal monitor that constitutes the car navigation device. The car navigation device constituting the output unit 24 outputs, for example, information using at least either of an image and a sound.

The output unit 24 is not limited to this, and may include any output device that affects at least either of visual and auditory senses of the occupant of the vehicle 20. The output unit 24 may include, for example, any audio output device other than the car navigation device, which mainly affects the hearing of the occupants of the vehicle 20. The output unit 24 may include, for example, any image output device other than the car navigation device, which mainly affects the visual sense of the occupants of the vehicle 20.

The input unit 25 includes, for example, one or more input interfaces that receive an input operation by the occupant in response to the information output by the output unit 24 and acquire input information based on the input operation by the occupant. For example, the input unit 25 includes a car navigation device that constitutes the output unit 24. For example, the input unit 25 includes a touch screen provided integrally with the liquid crystal monitor constituting the car navigation device. The car navigation device constituting the input unit 25 receives, for example, the input operation by the occupant based on a touch operation by the occupant.

The input unit 25 is not limited to this, and may include any input interface capable of detecting the input operation by the occupant and acquiring the input information based on the input operation by the occupant. The input unit 25 may include, for example, a physical key, a capacitance key, and a microphone that accepts voice inputs.

The control unit 26 includes one or more processors. According to the embodiment, the “processor” is a general-purpose processor or a dedicated processor specialized for specific processing. However, the processor is not limited thereto. For example, the control unit 26 may include an electronic control unit (ECU). The control unit 26 is communicably connected to each component constituting the vehicle 20 and controls the operation of the entire vehicle 20.

The control unit 26 acquires the traveling information and the location information of the vehicle 20 based on traveling of the vehicle 20 for the occupant of the vehicle 20. At this time, the vehicle 20 determines, for example, identification information of the occupant who is on board the vehicle 20. In the present specification, the “identification information” includes, for example, an identification (ID) of the occupant of the vehicle 20. The vehicle 20 specifies the identification information of the occupant based on, for example, the input operation by the occupant using a touch screen provided integrally with the liquid crystal monitor constituting the car navigation device of the input unit 25. A method of specifying the identification information is not limited to this, and the vehicle 20 may specify the identification information of the occupant who is on board the vehicle 20 by identifying a face of the occupant through face recognition using the camera module constituting the acquisition unit 23 and collating the face of the occupant with the identification information of the occupant stored in the storage unit 22. The vehicle 20 may specify the identification information of the occupant who is on board the vehicle 20 by identifying a fingerprint of the occupant through fingerprint recognition using the camera module constituting the acquisition unit 23 and collating the fingerprint of the occupant with the identification information of the occupant stored in the storage unit 22.

The control unit 26 transmits the acquired traveling information and location information of the vehicle 20 and the specified occupant identification information to the information processing device 10 via the communication unit 21 and the network 30. In addition, the control unit 26 transmits the occupant information and the number of occupants acquired by the acquisition unit 23 to the information processing device 10 via the communication unit 21 and the network 30.

The control unit 26 receives arbitrary information determined, generated, or estimated by the information processing device 10 from the information processing device 10 via the network 30 and the communication unit 21. For example, the control unit 26 receives the destination information determined by the information processing device 10 based on the preference information of the occupant from the information processing device 10 via the network 30 and the communication unit 21.

Next, the configuration of the information processing device 10 included in the information processing system 1 will be mainly described. As shown in FIG. 2, the information processing device 10 includes a communication unit 11, a storage unit 12, and a control unit 13.

The communication unit 11 includes a communication module connected to the network 30. For example, the communication unit 11 may include a communication module compatible with mobile communication standards such as 4G and 5G or the Internet standards. According to the embodiment, the information processing device 10 is connected to the network 30 via the communication unit 11. The communication unit 11 transmits and receives various types of information via the network 30.

The storage unit 12 is, for example, a semiconductor memory, a magnetic memory, or an optical memory. However, the storage unit 12 is not limited to these memories. The storage unit 12 may function as, for example, a main storage device, an auxiliary storage device, or a cache memory. The storage unit 12 stores arbitrary information used for the operation of the information processing device 10. For example, the storage unit 12 may store a system program, an application program, and various types of information received by the communication unit 11. The information stored in the storage unit 12 may be updatable with information received from the network 30 via the communication unit 11, for example.

The control unit 13 includes one or more processors. According to the embodiment, the “processor” is a general-purpose processor or a dedicated processor specialized for specific processing. However, the processor is not limited thereto. The control unit 13 is communicatively connected to each of the constituent units of the information processing device 10 and controls the overall operation of the information processing device 10.

For example, the control unit 13 receives the traveling information and the location information of the vehicle 20 acquired based on the past traveling of one or more of the vehicles 20 for the one occupant of the vehicle 20 from the vehicle 20 via the network 30 and the communication unit 11. At this time, the control unit 13 receives the occupant identification information specified by the vehicle 20 from the vehicle 20 via the network 30 and the communication unit 11.

The control unit 13 generates the preference information of the one occupant based on the acquired traveling information and the location information. When the control unit 13 determines that the occupant who is on board the vehicle 20 is the one occupant who has boarded the same or different vehicle 20 in the past and the preference information is generated for the same occupant, the control unit 13 determines the destination information based on the preference information of the occupant. The control unit 13 transmits the determined destination information to the vehicle 20 via the communication unit 11 and the network 30. At this time, the vehicle 20 may start automated driving heading for one facility related to the destination information automatically determined by the control unit 13, or may start automated driving heading for one of a plurality of facilities that are related to the destination information and selected by the occupant using the input unit 25.

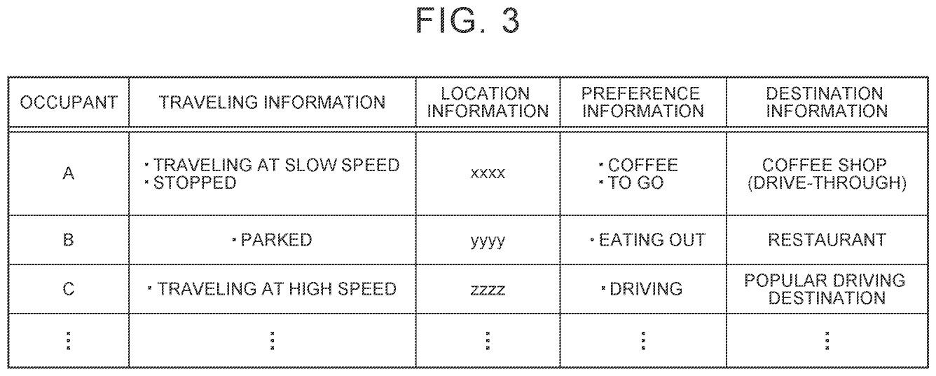

FIG. 3 is a diagram for explaining a first example of processing executed by the control unit 13 of the information processing device 10 shown in FIG. 2. The first example of the processing executed by the control unit 13 will be described more specifically with reference to FIG. 3. In the first example of the processing executed by the control unit 13, the preference information of the one occupant is generated based on the traveling information and the location information acquired by the control unit 13, and the destination information is determined. FIG. 3 shows identification information A, identification information B, and identification information C of three occupants, respectively. However, the number of occupants relating to the destination information determined by the control unit 13 may not necessarily be three.

The control unit 13 acquires the traveling information of the vehicle 20 acquired based on the past traveling of one or more of the vehicles 20 for the occupant of the identification information A. For example, the control unit 13 acquires information that the vehicle 20 is decelerated based on a speed of the vehicle 20 traveling at a low speed and the shift lever fixed to the drive position. In addition, the control unit 13 acquires information that the vehicle 20 is stopped based on the speed of the vehicle 20 being zero and the shift lever operation changed to the neutral position. The control unit 13 acquires the information “xxxx” as the location information of the vehicle 20 acquired based on the past traveling of the vehicle 20 for the occupant of the identification information A.

At this time, the control unit 13 generates the preference information of the one occupant based on the traveling information and the location information that are acquired. For example, the control unit 13 generates information “coffee” as the preference for food and drink of the occupant of the identification information A because the location information “xxxx” is associated with the coffee shop and many other similar types of information are acquired for the occupant of the identification information A. In addition, the control unit 13 generates information “to go” as the preference regarding the eating and driving method of the occupant of the identification information A because the traveling information such as “traveling at a slow speed” and “stopped” corresponds to the operation of the vehicle 20 at a drive-through shop and many other similar types of information are acquired for the occupant of the identification information A.

The control unit 13 determines whether the occupant of the identification information A who is on board the vehicle 20 is the one occupant who has boarded the same or different vehicle 20 in the past, and the preference information is generated for the occupant. When the control unit 13 determines that the conditions above are satisfied for the occupant of the identification information A, the control unit 13 determines that the coffee shop provided with the drive-through feature as the destination information based on the preference information of the occupant of the identification information A.

The control unit 13 acquires the traveling information of the vehicle 20 acquired based on the past traveling of one or more of the vehicles 20 for the occupant of the identification information B. In addition, the control unit 13 acquires information that the vehicle 20 is parked based on the speed of the vehicle 20 being zero and the shift lever changed to the parking position. The control unit 13 acquires the information “yyyy” as the location information of the vehicle 20 acquired based on the past traveling of the vehicle 20 for the occupant of the identification information B.

At this time, the control unit 13 generates the preference information of the one occupant based on the traveling information and the location information that are acquired. For example, the control unit 13 generates information “eating out” as the preference for the method of eating and driving of the occupant of the identification information B because the location information “yyyy” is associated with a restaurant and many other similar types of information are acquired for the occupant of the identification information B.

The control unit 13 determines whether the occupant of the identification information B who is on board the vehicle 20 is the one occupant who has boarded the same or different vehicle 20 in the past, and the preference information is generated for the occupant. When the control unit 13 determines that the conditions above are satisfied for the occupant of the identification information B, the control unit 13 determines the restaurant as the destination information based on the preference information of the occupant of the identification information B.

The control unit 13 acquires the traveling information of the vehicle 20 acquired based on the past traveling of one or more of the vehicles 20 for the occupant of the identification information C. For example, the control unit 13 acquires information that the vehicle 20 is traveling at a high speed based on the speed of the vehicle 20. The control unit 13 acquires the information “zzzz” as the location information of the vehicle 20 acquired based on the past traveling of the vehicle 20 for the occupant of the identification information C.

At this time, the control unit 13 generates the preference information of the one occupant based on the traveling information and the location information that are acquired. For example, the control unit 13 generates information “driving” as the preference for the hobby of the occupant of the identification information C because the location information “zzzz” is associated with a popular driving destination and many other similar types of information are acquired for the occupant of the identification information C.

The control unit 13 determines whether the occupant of the identification information C who is on board the vehicle 20 is the one occupant who has boarded the same or different vehicle 20 in the past, and the preference information is generated for the occupant. When the control unit 13 determines that the conditions above are satisfied for the occupant of the identification information C, the control unit 13 determines the popular driving destination as the destination information based on the preference information of the occupant of the identification information C.

For example, when the destination information includes the location information of the facility that reflects the preference of the occupant based on the preference information, the control unit 13 generates display information for superimposing and displaying the location of the facility on the map based on the location information of the facility. The control unit 13 transmits the generated display information to the vehicle 20 via the communication unit 11 and the network 30. The display information transmitted to the vehicle 20 is output, for example, by the output unit 24 of the vehicle 20.

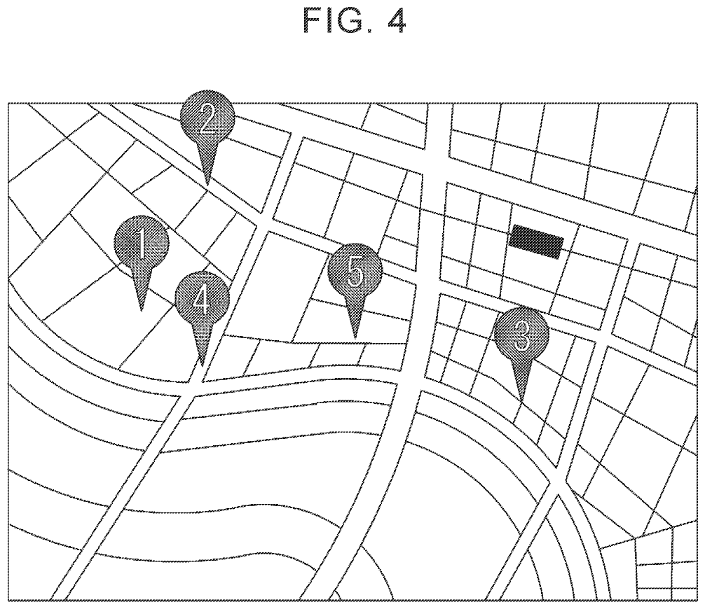

FIG. 4 is a diagram for explaining a second example of the processing executed by the control unit 13 of the information processing device 10 shown in FIG. 2. The second example of the processing executed by the control unit 13 will be described more specifically with reference to FIG. 4. In the second example of the processing executed by the control unit 13, the control unit 13 generates the display information for superimposing and displaying the location of the facility on the map based on the location information of the facility.

For example, as shown in FIG. 4, the control unit 13 generates the display information for superimposing and displaying an arbitrary location marking that indicates the location of the facility reflecting the preference of the occupant based on the preference information on the map. Further, the control unit 13 receives the occupant information acquired by the acquisition unit 23 of the vehicle 20 from the vehicle 20 via the network 30 and the communication unit 11. At this time, the control unit 13 optimizes the display information based on at least either of the occupant information of the occupant of the vehicle 20 and evaluation information of the facility. In the present specification, “evaluation information” includes, for example, evaluation based on a key performance indicator (KPI) of the facility and any other index. For example, the control unit 13 may acquire the evaluation information from an arbitrary external device connected to the network 30, or may acquire the evaluation information acquired from a terminal device, etc., used by the vehicle 20 or the occupant of the vehicle 20 in the past and stored in the storage unit 12 by reading the evaluation information from the storage unit 12.

For example, when the control unit 13 optimizes the display information based on the evaluation information of the facility, as shown in FIG. 4, the control unit 13 assigns the number 1 to the facility having the highest evaluation information and generates the display information for superimposing and displaying the number 1 over the location marking of the facility. Similarly, the control unit 13 assigns the numbers in ascending order from the facility with the highest evaluation information, and generates display information for superimposing and displaying the corresponding number over the location marking of the facility.

Generation of the display information is not limited to the above. The control unit 13 may generate, for example, display information for displaying only the facilities having evaluation information being higher than a predetermined threshold value using the location marking. For example, the control unit 13 may generate the display information for highlighting the location marking of the facility as the evaluation information is higher. For example, the control unit 13 may generate the display information for enlarging the location marking of the facility as the evaluation information is higher. For example, the control unit 13 may generate the display information for displaying the location marking of the facility using a more noticeable color as the evaluation information is higher. For example, the control unit 13 may generate the display information for more frequently blinking the location marking of the facility as the evaluation information is higher.

When the control unit 13 optimizes the display information based on the occupant information of the occupant of the vehicle 20, for example, the control unit 13 may generate the display information for displaying only the facilities that match the occupant information using the location marking. For example, when the control unit 13 acquires the occupant information that the occupant is an adult male and is wearing a suit, the control unit 13 may generate the display information for displaying only the facilities provided with the drive-through feature using the location marking, based on the determination that the occupant is a businessman, so as to support the occupant who is a busy businessman having less time for eating. For example, when the control unit 13 determines that a fatigue level of the occupant is becoming high based on the contents of conversation and behavior of the occupant because boarding time of the occupant becomes long, the control unit 13 may generate the display information for displaying, using the location marking, only the facilities where the vehicle 20 can arrive within a predetermined time from the present time and the occupant of the vehicle 20 can have a rest.

When the control unit 13 optimizes the display information based on the occupant information of the occupant of the vehicle 20, for example, the control unit 13 may generate the display information for displaying the facilities that match the occupant information using the highlighted location marking. For example, when the control unit 13 determines that the occupant of the vehicle 20 is a businessman, the control unit 13 may generate the display information for displaying the facility that requires less time to purchase the product at the drive-through feature with enlarging the location marking of the facility, displaying the locating marking using a more noticeable color, or blinking the location marking more frequently. For example, when the control unit 13 determines that the fatigue level of the occupant is becoming high, the control unit 13 may generate the display information for displaying the facility that the vehicle 20 can arrive within a shorter time from the present time by enlarging the location marking of the facility, displaying the location marking using a more noticeable color, or blinking the location marking more frequently.

For example, the control unit 13 determines service information related to a service that is provided at the facility and matches the occupant information of the occupant of the vehicle 20. The control unit 13 transmits the determined service information to the vehicle 20 via the communication unit 11 and the network 30. The service information transmitted to the vehicle 20 is output, for example, by the output unit 24 of the vehicle 20. In the present specification, the “service information” includes, for example, menus, contents, and advertisements, etc. of products or services provided at the facility.

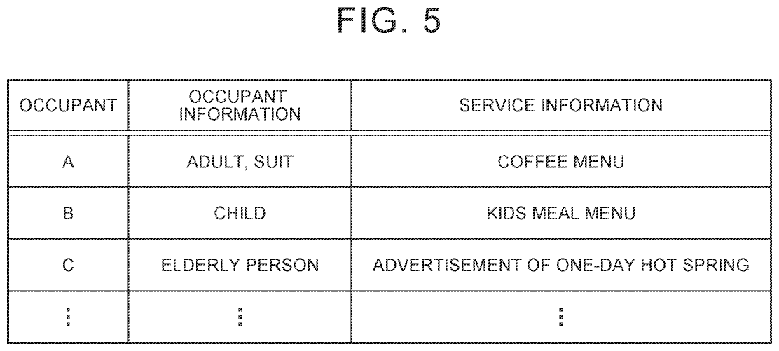

FIG. 5 is a diagram for explaining a third example of the processing executed by the control unit 13 of the information processing device 10 shown in FIG. 2. The third example of the processing executed by the control unit 13 will be described more specifically with reference to FIG. 5. In the third example of the processing executed by the control unit 13, the control unit 13 determines the service information that matches the occupant information of the occupant acquired from the vehicle 20. FIG. 5 shows identification information A, identification information B, and identification information C of three occupants, respectively. However, the number of occupants relating to the service information determined by the control unit 13 may not necessarily be three.

For example, the control unit 13 acquires the occupant information that the occupant of the identification information A is an adult and is wearing a suit. At this time, the control unit 13 determines that the occupant of the identification information A is a business person, and determines the coffee menu provided at the coffee shop as the service information that matches the acquired occupant information.

For example, the control unit 13 acquires the occupant information that the occupant of the identification information B is a child. At this time, the control unit 13 determines the kids meal menu provided at the restaurant as the service information that matches the acquired occupant information.

For example, the control unit 13 acquires the occupant information that the occupant of the identification information C is an elderly person. At this time, the control unit 13 determines the advertisement for a one-day hot spring service provided at a hot spring facility, which is also a popular driving destination, as the service information that matches the acquired occupant information.

The control unit 13 may execute reservation processing with the facility based on the determined service information. For example, the control unit 13 execute the reservation processing with the product or the service selected based on the input operation by the occupant of the vehicle 20 using the input unit 25 based on the service information above output from the output unit 24 of the vehicle 20. For example, the control unit 13 may make a reservation of the order of the coffee product selected by the occupant of the vehicle 20 with the selected coffee shop. For example, the control unit 13 may make a reservation of the order of the kids meal selected by the occupant of the vehicle 20 with the restaurant. For example, the control unit 13 may make a reservation of the ticket for the one-day hot spring selected by the occupant of the vehicle 20 with the selected hot spring facility.

The processing is not limited to the above, and the control unit 13 may determine an optimum product or service for the occupant by the control unit 13 without receiving the input operation by the occupant of the vehicle 20 using the input unit 25, and automatically make a reservation with the corresponding facility.

The control unit 13 receives the past data in which the number of occupants acquired by the acquisition unit 23 of the vehicle 20 heading for a predetermined facility is associated with staying time at the facility determined based on the stop time or the parking time in the traveling information from the vehicle 20 via the network 30 and the communication unit 11. The control unit 13 estimates current and future congestion information of the facility based on the acquired past data. The control unit 13 transmits the estimated congestion information to the vehicle 20 via the communication unit 11 and the network 30. The congestion information transmitted to the vehicle 20 is output, for example, by the output unit 24 of the vehicle 20. In the present specification, the “congestion information” includes a current congestion status of the facility and a transition of the congestion status in the future.

The control unit 13 determines, based on the estimated congestion information, time when the vehicle 20 that guides the occupant arrives the facility or a waiting time at the facility occurring after the vehicle 20 that guides the occupant arrives the facility such that occurrence of the waiting time is avoided. The control unit 13 transmits the determined arrival time or the waiting time to the vehicle 20 via the communication unit 11 and the network 30. The arrival time or the waiting time transmitted to the vehicle 20 is output by, for example, the output unit 24 of the vehicle 20.

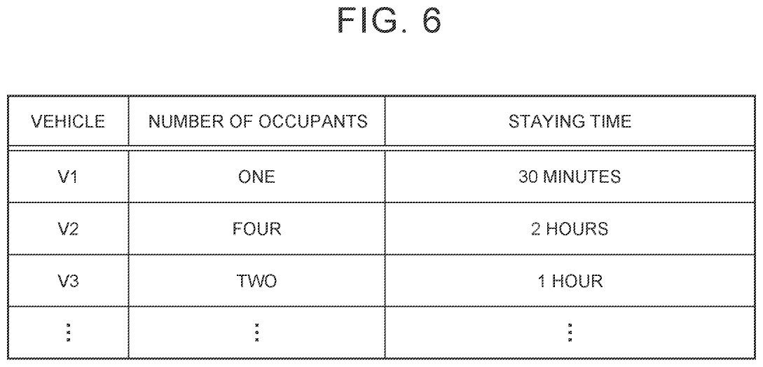

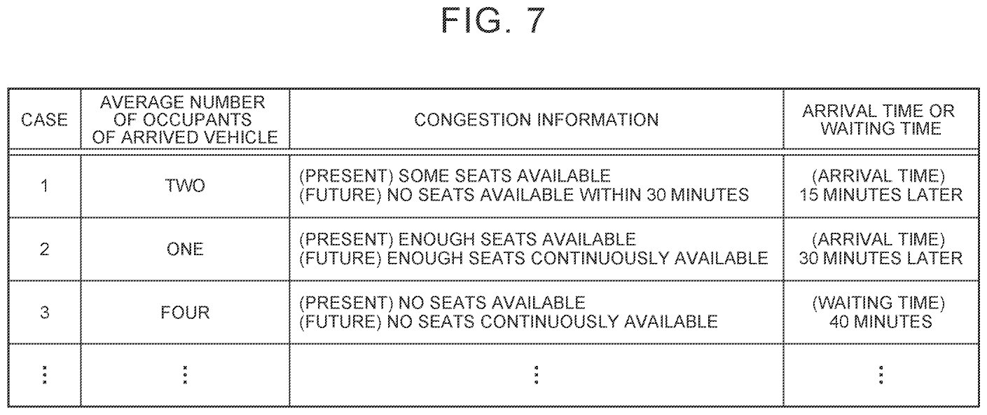

FIG. 6 is a first diagram for explaining a fourth example of the processing executed by the control unit 13 of the information processing device 10 shown in FIG. 2. FIG. 7 is a second diagram for explaining the fourth example of the processing executed by the control unit 13 of the information processing device 10 shown in FIG. 2. The fourth example of the processing to be executed by the control unit 13 will be described more specifically with reference to FIGS. 6 and 7. In the fourth example of the processing executed by the control unit 13, the control unit 13 estimates the congestion information based on the past data as shown in FIG. 6 acquired from the vehicle 20. FIG. 6 shows three vehicles V1, V2, and V3 as the vehicle 20. However, the number of the vehicles 20 included in the past data may not necessarily be three. For example, the past data in which the number of occupants of the vehicle 20 heading for a predetermined facility is associated with the staying time at the facility may be acquired by one vehicle 20. Similarly, FIG. 7 show three cases 1, 2, and 3 at the predetermined facility. However, the number of cases relating to the congestion information estimated by the control unit 13 may not necessarily be three.

For example, in the past data acquired from the vehicle 20, the number of occupants when the vehicle V1 heads for the predetermined facility is one, and the staying time at the facility is 30 minutes. Similarly, the number of occupants when the vehicle V2 heads for the predetermined facility is four, and the staying time at the facility is two hours. Further, the number of occupants when the vehicle V3 heads for the predetermined facility is two, and the staying time at the facility is one hour.

For example, the control unit 13 receives the number of occupants of one or more vehicles 20 arriving at the predetermined facility from the vehicle 20 via the network 30 and the communication unit 11. The control unit 13 determines an average number of occupants of the vehicle 20 arriving at the predetermined facility based on the acquired number of occupants of each vehicle 20. For example, in the case 1, the control unit 13 determines that the average number of occupants of the vehicle 20 arriving at the predetermined facility is two. In this case, the control unit 13 estimates the congestion information that some seats are currently available at the predetermined facility but will be occupied within 30 minutes from the present time with reference to the past data relating to the vehicle V3 shown in FIG. 6. The control unit 13 determines the time when the vehicle 20 that guides the occupants arrives the predetermined facility to be 15 minutes later based on the estimated congestion information such that the occupant does not need to have the waiting time at the predetermined facility.

Similarly, in the case 2, the control unit 13 determines that the average number of occupants of the vehicle 20 arriving at the predetermined facility is one, for example. In this case, the control unit 13 estimates the congestion information that enough seats are currently available at the predetermined facility and will be continuously available from the present time with reference to the past data relating to the vehicle V1 shown in FIG. 6. The control unit 13 determines the time when the vehicle 20 that guides the occupants to be 30 minutes later based on the estimated congestion information such that the occupant does not need to have the waiting time at the predetermined facility.

Similarly, in the case 3, the control unit 13 determines that the average number of occupants of the vehicle 20 arriving at the predetermined facility is four, for example. In this case, the control unit 13 estimates the congestion information that there are no available seats at the predetermined facility and there will be no seats available continuously from the present time with reference to the past data relating to the vehicle V2 shown in FIG. 6. The control unit 13 determines the waiting time at the facility that occurs after the vehicle 20 that guides the occupants arrives the predetermined facility to be 40 minutes based on the estimated congestion information.

For example, the vehicle 20 may output an optimum arrival time for each of a plurality of facilities output to the output unit 24 and receive the input operation by the occupant to select the optimum facility as the final destination using the input unit 25. The vehicle 20 may start automated driving so as to arrive the facility selected at the corresponding arrival time based on the input operation above. The processing is not limited to the above, and the vehicle 20 may, for example, automatically select the facility with which the time to arrive from the present time is the shortest and start automated driving such that the vehicle 20 arrives the selected facility at the corresponding arrival time.

For example, the vehicle 20 may output the waiting time for each of the facilities output to the output unit 24 and receive the input operation by the occupant to select the optimum facility as the final destination using the input unit 25. The vehicle 20 may start automated driving toward the selected facility based on the input operation above. The start of automated driving is not limited to the above, and the vehicle 20 may, for example, automatically select the facility with which the time to arrive from the present time is the shortest and start automated driving for the selected facility.

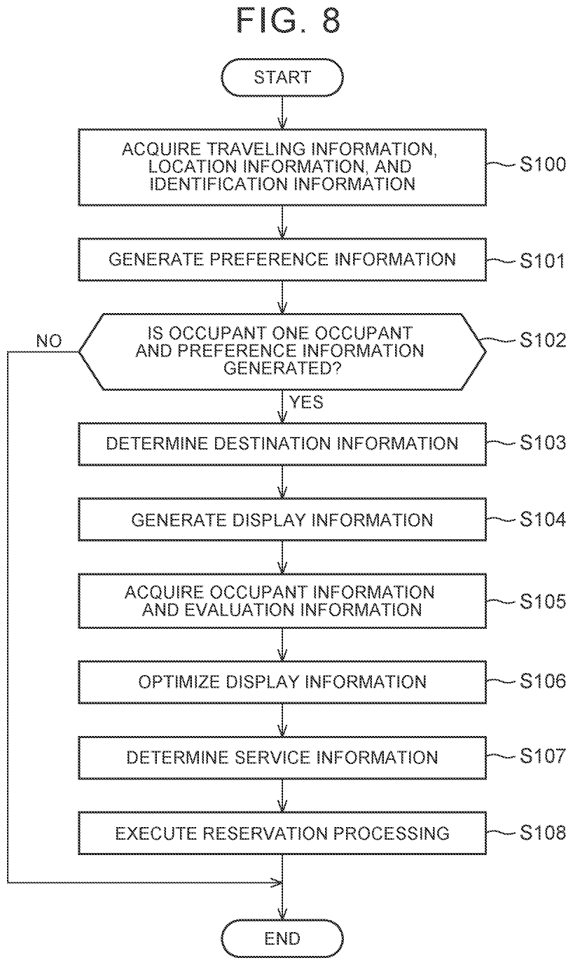

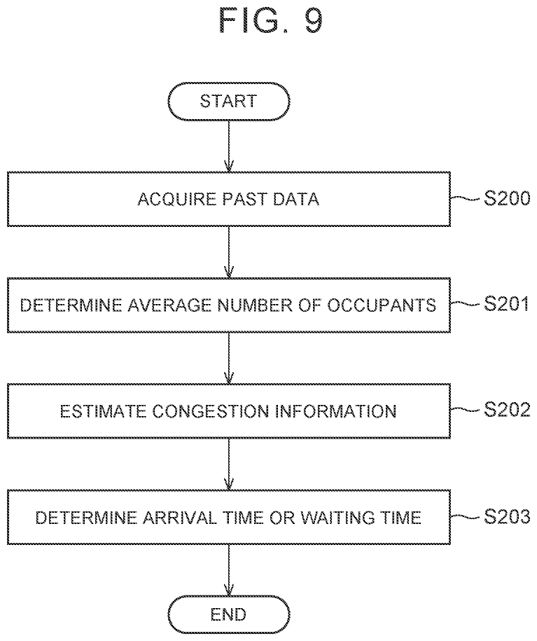

Next, an information processing method executed by the control unit 13 of the information processing device 10 according to the embodiment will be described with reference to FIGS. 8 and 9. FIG. 8 is a flowchart for explaining a first example of the information processing method executed by the information processing device 10 shown in FIG. 1.

In step S100, the control unit 13 acquires the traveling information and the location information of the vehicle 20 acquired based on the past traveling of one or more of the vehicles 20 for the one occupant of the vehicle 20 from the vehicle 20. In addition, the control unit 13 acquires the identification information of the one occupant from the vehicle 20.

In step S101, the control unit 13 generates preference information of the one occupant based on the traveling information and the location information acquired in step S100.

In step S102, the control unit 13 determines whether the occupant who is on board the vehicle 20 is the one occupant who has boarded the same or different vehicle 20 in the past and the preference information is generated for the occupant. When the control unit 13 determines that the conditions above are satisfied, the control unit 13 executes the processing in step S103. When the control unit 13 determines that at least either of the conditions is not satisfied, the control unit 13 terminates the routine.

In step S103, when the control unit 13 determines in step S102 that the occupant who is on board the vehicle 20 is the one occupant who has boarded the vehicle 20 in the past and the preference information is generated for the occupant, the control unit 13 determines the destination information based on the preference information of the occupant generated in step S101.

In step S104, when the destination information determined in step S103 includes the location information of the facility reflecting the preference of the occupant based on the preference information, the control unit 13 generates the display information for superimposing and displaying the location of the facility on the map based on the location information of the facility.

In step S105, the control unit 13 acquires the occupant information of the occupant of the vehicle 20 and the evaluation information of the facility from the vehicle 20 and the arbitrary external device, respectively.

In step S106, the control unit 13 optimizes the display information based on at least either of the occupant information of the occupant of the vehicle 20 and the evaluation information of the facility acquired in step S105.

In step S107, the control unit 13 determines the service information related to the service that is provided at the facility and matches the occupant information of the occupant of the vehicle 20 acquired in step S105.

In step S108, the control unit 13 executes the reservation processing with the facility based on the service information determined in step S107.

FIG. 9 is a flowchart for explaining a second example of the information processing method executed by the information processing device 10 shown in FIG. 1.

In step S200, the control unit 13 acquires past data from the vehicle 20 that associates the number of occupants of the vehicle 20 heading for the predetermined facility with the staying time at the facility.

In step S201, the control unit 13 acquires the number of occupants of one or more of the vehicles 20 arriving at the predetermined facility at present from the vehicle 20, and determines the average number of occupants of the vehicle 20 arriving at the facility.

In step S202, the control unit 13 estimates the current and future congestion information of the facility based on the past data acquired in step S200. More specifically, the control unit 13 estimates the congestion information by collating the average number of occupants determined in step S201 with the past data acquired in step S200.

In step S203, the control unit 13 determines, based on the congestion information estimated in step S202, the time when the vehicle 20 that guides the occupant arrives the facility or the waiting time at the facility occurring after the vehicle 20 that guides the occupant arrives the facility such that occurrence of the waiting time is avoided.

According to the embodiment above, the information tailored to the preferences of the occupants of the vehicle 20 can be provided for each occupant. For example, the information processing device 10 determines the destination information based on the preference information of the occupant, which makes it possible for the output unit 24 of the vehicle 20 that acquires the destination information to provide the occupant of the vehicle 20 with the information that matches the preference information of the occupant. With the processing above, the occupant can acquire the information that matches the preference of the occupant from the output unit 24 of the vehicle 20, unlike the conventional car navigation device in which the information is uniformly provided. Consequently, the convenience and satisfaction of the occupant with respect to the information distribution via the output unit 24 of the vehicle 20 are improved.

The information processing device 10 generates the display information for superimposing and displaying the location of the facility on the map based on the location information of the facility, and the output unit 24 of the vehicle 20 that acquires the display information can provide the occupant of the vehicle 20 with the optimum map display that matches the preference information of the occupant. With the processing above, the occupant can acquire the map display that matches the preference of the occupant from the output unit 24 of the vehicle 20, unlike the conventional car navigation device in which map display is uniformly described. Consequently, the convenience and satisfaction of the occupant with respect to the information distribution via the output unit 24 of the vehicle 20 are improved.

The information processing device 10 optimizes the display information based on at least either of the occupant information of the occupant of the vehicle 20 and the evaluation information of the facility, which makes it possible for the output unit 24 of the vehicle 20 that acquires the display information to provide the occupant of the vehicle 20 with information that matches at least either of the occupant information and the evaluation information of the facility, in addition to the preference information of the occupant. Consequently, unlike the conventional car navigation device in which information is uniformly provided, the occupant can acquire, from the output unit 24 of the vehicle 20, the information that matches at least either of the occupant information and the evaluation information of the facility, in addition to the preference of the occupant. For example, the occupant can easily select the optimum facility as the final destination from a plurality of candidate facilities determined based on the preference information with reference to at least either of the occupant information and the evaluation information of the facility. Consequently, the convenience and satisfaction of the occupant with respect to the information distribution via the output unit 24 of the vehicle 20 are further improved.

The information processing device 10 determines the service information related to the service that is provided at the facility and matches the occupant information of the occupant of the vehicle 20, which makes it possible for the output unit 24 of the vehicle 20 that acquires the service information to provide the occupant with the service information of an appropriate facility in response to the needs based on the occupant information. With the processing above, the occupant can acquire information that satisfies the needs based on the occupant information of the occupant from the output unit 24 of the vehicle 20, unlike the conventional car navigation device in which only uniform service information is provided. Consequently, the convenience and satisfaction of the occupant with respect to the information distribution via the output unit 24 of the vehicle 20 are improved.

The information processing device 10 executes the reservation processing based on the determined service information with the facility that matches the preference of the occupant, which improves the convenience for the occupant of the vehicle 20 as compared with the case where the occupant separately makes a reservation with the facility using a terminal device of the occupant. For example, the occupant of the vehicle 20 can make a reservation with the corresponding facility simply by selecting a specific product or service using the input unit 25 with respect to the service information output to the output unit 24. For example, the occupant of the vehicle 20 can make a reservation with the corresponding facility without performing any special operation using the input unit 25 of the vehicle 20 as the control unit 13 automatically executes the reservation processing with the facility that matches the preference of the occupant.

The information processing device 10 estimates the current and future congestion information of the predetermined facility based on the acquired past data, which makes it possible for the output unit 24 of the vehicle 20 that acquires the congestion information to provide the occupant of the vehicle 20 with the congestion information of the facility that matches the preference of the occupant accurately. With the processing above, for example, the occupant of the vehicle 20 can accurately grasp the congestion information of each of the facilities output to the output unit 24 and easily select the optimum facility as the final destination. Consequently, the convenience and satisfaction of the occupant with respect to the information distribution via the output unit 24 of the vehicle 20 are further improved.

The information processing device 10 determines the arrival time at the facility based on the estimated congestion information, which makes it possible for the output unit 24 of the vehicle 20 that acquires the determined arrival time information to accurately provide the occupant of the vehicle 20 with the optimal arrival time in response to the congestion information of the facility. Therefore, for example, the occupant of the vehicle 20 can accurately grasp the optimal arrival time for each of the facilities output to the output unit 24 and easily select the optimum facility as the final destination. Alternatively, for example, the vehicle 20 can automatically start driving toward the facility with which the time from the present time to the arrival time is the shortest. With the processing above, the waiting time of the occupant of the vehicle 20 at the facility is reduced, or the waiting time does not occur in the first place. Consequently, the convenience and satisfaction of the occupant of the vehicle 20 are further improved.

The information processing device 10 determines the waiting time occurring after the vehicle 20 arrives the facility based on the estimated congestion information, which makes it possible for the output unit 24 of the vehicle 20 that acquires the determined waiting time information to provide the occupant of the vehicle 20 with the accurate waiting time in response to the congestion information of the facility. With the processing above, for example, the occupant of the vehicle 20 can accurately grasp the waiting time of each of the facilities output to the output unit 24 and easily select the optimum facility as the final destination. Alternatively, for example, the vehicle 20 can automatically start driving toward the facility having the shortest waiting time. Consequently, the convenience and satisfaction of the occupant of the vehicle 20 are further improved.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each means, each step, etc. can be rearranged so as not to be logically inconsistent, and a plurality of means, steps, etc. can be combined into one or divided.

For example, at least a part of the processing operations executed by the information processing device 10 in the above embodiment may be executed by the vehicle 20. For example, instead of the information processing device 10, the vehicle 20 itself may execute the processing operations above related to the information processing device 10. At least a part of the processing operations executed by the vehicle 20 may be executed by the information processing device 10.

For example, a general-purpose electronic device such as a smartphone or a computer may be configured to function as the information processing device 10 according to the above embodiment. Specifically, a program describing the processing contents for realizing each function, such as the information processing device 10 according to the embodiment, is stored in a memory of the electronic device, and the program is read and executed by the processor of the electronic device. Therefore, the disclosure according to the embodiment can also be realized as a program that can be executed by the processor. Alternatively, the disclosure according to the embodiment can also be realized as a non-transitory computer-readable medium that stores a program executable by one or more processors to cause the information processing device 10 according to the embodiment, for example, to execute each function. It should be understood that the above configurations are also included in the scope of the present disclosure.

For example, the information processing device 10 described in the above embodiment may be mounted on the vehicle 20. With the configuration above, the information processing device 10 may directly perform information communication with the vehicle 20 without the network 30.

The above embodiment has been described that the information processing device 10 provides the vehicle 20 with arbitrary information that is determined, generated, or estimated by the information processing device 10, including the destination information, the display information, the service information, the congestion information, the arrival time or the waiting time. However, the present disclosure is not limited to this. The information processing device 10 may provide the terminal device of the occupant of the vehicle 20, in place of or in addition to the vehicle 20, with the above types of information. With the configuration above, the information processing system 1 may include the terminal device of the occupant of the vehicle 20 in place of or in addition to the information processing device 10 and the vehicle 20.

What is claimed is:

1. An information processing device, comprising a control unit that acquires traveling information and location information of a vehicle acquired based on past traveling of at least one vehicle for one occupant of the vehicle, the vehicle included in the at least one vehicle, generates preference information of the one occupant based on the traveling information and the location information that are acquired, and determines destination information based on the preference information of the occupant when the control unit determines that an occupant who is on board the vehicle is the one occupant who has boarded the vehicle in the past and the preference information is generated for the occupant.

2. The information processing device according to claim 1, wherein:
the destination information includes location information of a facility that reflects a preference of the occupant based on the preference information; and
the control unit generates display information for superimposing and displaying a location of the facility on a map based on the location information of the facility.

3. The information processing device according to claim 2, wherein the control unit optimizes the display information based on at least either of occupant information of the occupant of the vehicle and evaluation information of the facility.

4. The information processing device according to claim 2, wherein the control unit determines service information related to a service that is provided at the facility and matches occupant information of the occupant of the vehicle.

5. The information processing device according to claim 4, wherein the control unit executes reservation processing with the facility based on the determined service information.

6. The information processing device according to claim 2, wherein the control unit acquires past data in which the number of occupants of the vehicle heading for the facility is associated with staying time at the facility, and estimates current and future congestion information of the facility based on the acquired past data.

7. The information processing device according to claim 6, wherein the control unit determines, based on the estimated congestion information, time when the vehicle that guides the occupant arrives the facility or a waiting time at the facility occurring after the vehicle that guides the occupant arrives the facility such that occurrence of the waiting time at the facility is avoided.

8. An information processing system, comprising:
the information processing device according to claim 1; and
the vehicle that provides the information processing device with the traveling information and the location information.

9. A program that causes an information processing device to execute operations comprising:
acquiring traveling information and location information of a vehicle acquired based on past traveling of at least one vehicle for one occupant of the vehicle, the vehicle included in the at least one vehicle;
generating preference information of the one occupant based on the traveling information and the location information that are acquired;
determining whether an occupant who is on board the vehicle is the one occupant who has boarded the vehicle in the past and the preference information is generated for the occupant; and
determining destination information based on the preference information of the occupant when the information processing device determines that the occupant who is on board the vehicle is the one occupant who has boarded the vehicle in the past and the preference information is generated for the occupant.

10. The program according to claim 9, wherein:
the destination information includes location information of a facility that reflects a preference of the occupant based on the preference information; and
the operations include generating display information for superimposing and displaying a location of the facility on a map based on the location information of the facility.

11. The program according to claim 10, wherein the operations include optimizing the display information based on at least either of occupant information of the occupant of the vehicle and evaluation information of the facility.

12. The program according to claim 10, wherein the operations include determining service information related to a service that is provided at the facility and matches occupant information of the occupant of the vehicle.

13. The program according to claim 12, wherein the operations include acquiring past data in which the number of occupants of the vehicle heading for the facility is associated with staying time at the facility, and estimating current and future congestion information of the facility based on the acquired past data.

14. The program according to claim 13, wherein the operations include determining, based on the estimated congestion information, time when the vehicle that guides the occupant arrives the facility or a waiting time at the facility occurring after the vehicle that guides the occupant arrives the facility such that occurrence of the waiting time is avoided.

15. A vehicle, comprising a control unit that acquires traveling information and location information of a vehicle acquired based on past traveling of at least one vehicle for one occupant of the vehicle, the vehicle included in the at least one vehicle, generates preference information of the one occupant based on the traveling information and the location information that are acquired, and determines destination information based on the preference information of the occupant when the control unit determines that an occupant who is on board the vehicle is the one occupant who has boarded the vehicle in the past and the preference information is generated for the occupant.

16. The vehicle according to claim 15, wherein:
the destination information includes location information of a facility that reflects a preference of the occupant based on the preference information; and
the control unit generates display information for superimposing and displaying a location of the facility on a map based on the location information of the facility.

17. The vehicle according to claim 16, wherein the control unit optimizes the display information based on at least either of occupant information of the occupant of the vehicle and evaluation information of the facility.

18. The vehicle according to claim 16, wherein the control unit determines service information related to a service that is provided at the facility and matches occupant information of the occupant of the vehicle.

19. The vehicle according to claim 16, wherein the control unit acquires past data in which the number of occupants of the vehicle heading for the facility is associated with staying time at the facility, and estimates current and future congestion information of the facility based on the acquired past data.

20. The vehicle according to claim 19, wherein the control unit determines, based on the estimated congestion information, time when the vehicle that guides the occupant arrives the facility or a waiting time at the facility occurring after the vehicle that guides the occupant arrives the facility such that occurrence of the waiting time is avoided.
